(19) United States
(12) Patent Application Publication
(10) Pub. No.: US 2014/0245452 A1
(43) Pub. Date: Aug. 28, 2014

(54) RESPONDING TO A POSSIBLE PRIVACY LEAK

(71) Applicant: GENERAL INSTRUMENT CORPORATION, Horsham, PA (US)

(72) Inventors: Joshua B. Hurwitz, Niles, IL (US); Douglas A. Kuhlman, Inverness, IL (US); Loren J. Rittle, Lake Zurich, IL (US)

(73) Assignee: GENERAL INSTRUMENT CORPORATION, Horsham, PA (US)

(21) Appl. No.: 13/777,090

(22) Filed: Feb. 26, 2013

(51) Int. Cl. H04L 29/06

(52) U.S. Cl. CPC H04L 63/04
USPC 726/26

(57) ABSTRACT

When a user is about to perform a “communicative act” (e.g., to send an e-mail or to post to a social-networking site), the proposed communicative act is reviewed to see if it may lead to a privacy leak. If, upon review, it is determined that performing the proposed communicative act could lead to a privacy leak, then an appropriate response is taken, such as preventing the proposed act from being performed or suggesting a modification to the proposed act that would lessen the likelihood of a privacy leak. A privacy server creates a privacy profile for a user based on information about the user's personae and how those personae are used. Using that profile, the privacy server can judge whether a proposed communicative act would support an unwanted inference.

### TECHNICAL FIELD

The present disclosure is related generally to electronic communications and, more particularly, to privacy protection.

### BACKGROUND

Users who have large amounts of personal information online typically want to restrict exposure of certain information that they consider sensitive. To do this, they may segregate exposure of information based on friendship categories (work friends, non-work friends, relatives, etc.). Furthermore, to avoid leaking sensitive information from one type of friend to another, they may create a different persona for each friendship category. Thus, they may create one online persona for non-work friends that they use to discuss their personal relationships and another for colleagues that they use to discuss work projects.

In order to strictly separate the different parts of their life, users may construct separate personae so as to minimize the likelihood that individuals who know them under one persona can link them to another persona. For example, users may use a different name, nickname, email address, user ID, or other designation for each persona. They may also avoid associating information about activities and interests with each of the personae that could be used to link one persona to any of the other personae.

### BRIEF DESCRIPTION OF THE SEVERAL VIEWS OF THE DRAWINGS

While the appended claims set forth the features of the present techniques with particularity, these techniques, together with their objects and advantages, may be best understood from the following detailed description taken in conjunction with the accompanying drawings of which:

FIG. 1 is an overview of a representative environment in which the present techniques may be practiced;

FIG. 2 is a generalized schematic of some of the devices of FIG. 1;

FIG. 3 is a flowchart of a representative method for responding to a possible privacy leak; and

FIGS. 4a and 4b together form a flowchart of a representative method for creating and using a privacy profile.

### DETAILED DESCRIPTION

Turning to the drawings, wherein like reference numerals refer to like elements, techniques of the present disclosure are illustrated as being implemented in a suitable environment. The following description is based on embodiments of the claims and should not be taken as limiting the claims with regard to alternative embodiments that are not explicitly described herein.

As the number of interactions and the amount of content and other information associated with each persona increases, there is a greater chance of leaking information that could be used to logically link personae together. Such leaks could result from a user communicating information that identifies one of his personae while logged in as another persona. For example, a user could accidentally reveal his pseudonym for one persona while talking with a friend who knows him under another persona.

While some such leaks are easy to identify and prevent, a more difficult case arises when information from different contexts in one persona can be combined together to make an inference about another persona. For example, consider a user who has one persona, his “professional persona,” as an employee and another, his “social persona,” as a single person looking to meet other singles. He might mention in one posting of his social persona that he is an engineer and in another posting that he is available to meet people at a bar on his way home from work in Libertyville. Based on these two pieces of information about his social persona, an outside observer might be able to infer something relevant to his professional persona (e.g., which engineering firm this person works for), an inference that the user may wish to avoid.

Another complication for users is the increased privacy risk when two or more personae are linked together. This risk arises from unwanted inferences that can be made by combining information from the different personae. If users assume that their personae will always be separate, they may not be censoring the information they provide for each persona in order to mitigate such a risk. However, if two personae are linked together, then the combined information could be used to infer sensitive information that users are trying to hide.

According to aspects of the present disclosure, when a user is about to perform a “communicative act” (e.g., to send an e-mail or to post to a social-networking site), the proposed communicative act is reviewed to see if it may lead to a privacy leak. If, upon review, it is determined that performing the proposed communicative act could lead to a privacy leak, then an appropriate response is taken, such as preventing the proposed act from being performed or suggesting a modification to the proposed act that would lessen the likelihood of a privacy leak.

As a first example, consider a user who, for privacy (or other) reasons, uses different personae in different contexts. The user associates the proposed communicative act with one of his personae. If, upon review, it seems that performing the proposed communicative act could lead an outsider to infer that this persona is somehow linked to another of the user's personae, then appropriate action could be taken to prevent that inference.

Other inferences that should be prevented include an inference about a persona other than the persona associated with the proposed communicative act. It might also be useful to prevent inferences about the user himself based on knowledge gleamed from multiple communicative acts.

In some embodiments, a privacy server creates a privacy profile for a user based on information about the user's personae and how those personae are used. Using that profile, the privacy server can judge whether a proposed communicative act would support an unwanted inference.

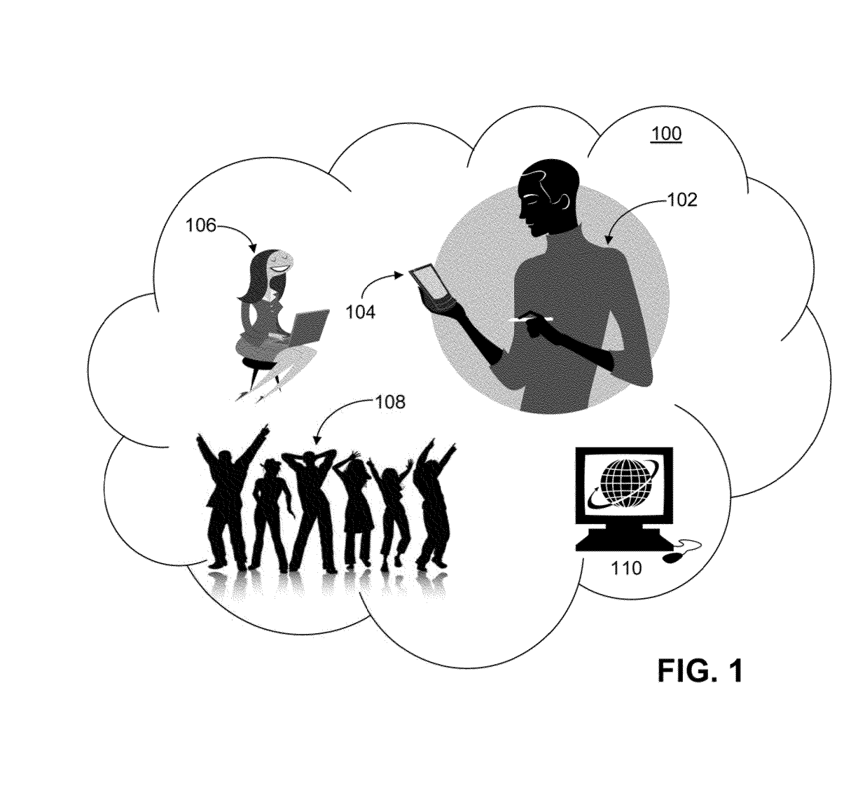

Consider the representative communications environment 100 of FIG. 1. The user 102 has established multiple personae for himself, using different personae for different communicative tasks. For example, when the user 102 uses his personal computing device 104 to communicate with a professional colleague 106, he uses a “professional persona.” When the user 102 wishes to communicate with his fellows in a particular social group 108, he instead uses a “social persona.” As discussed above, for privacy reasons the user 102 wishes to keep his professional and social personae separate. To do this, he tries to segregate communicative information so that, for example, social information does not “leak” into his professional persona.

While for clarity's sake FIG. 1 only depicts two groups 106, 108 with which the user 102 communicates, this case can clearly be extended. The user 102 may establish separate personae for multiple social groups, for his close family, for his church group, and the like. Extending the example, if the user 102 is a professional consultant or doctor, he may wish to have a separate persona to use with each of his clients. In this case, the separate personae are used to protect the privacy of his clients rather than that of the user 102 himself. The techniques discussed below can be applied to this scenario also.

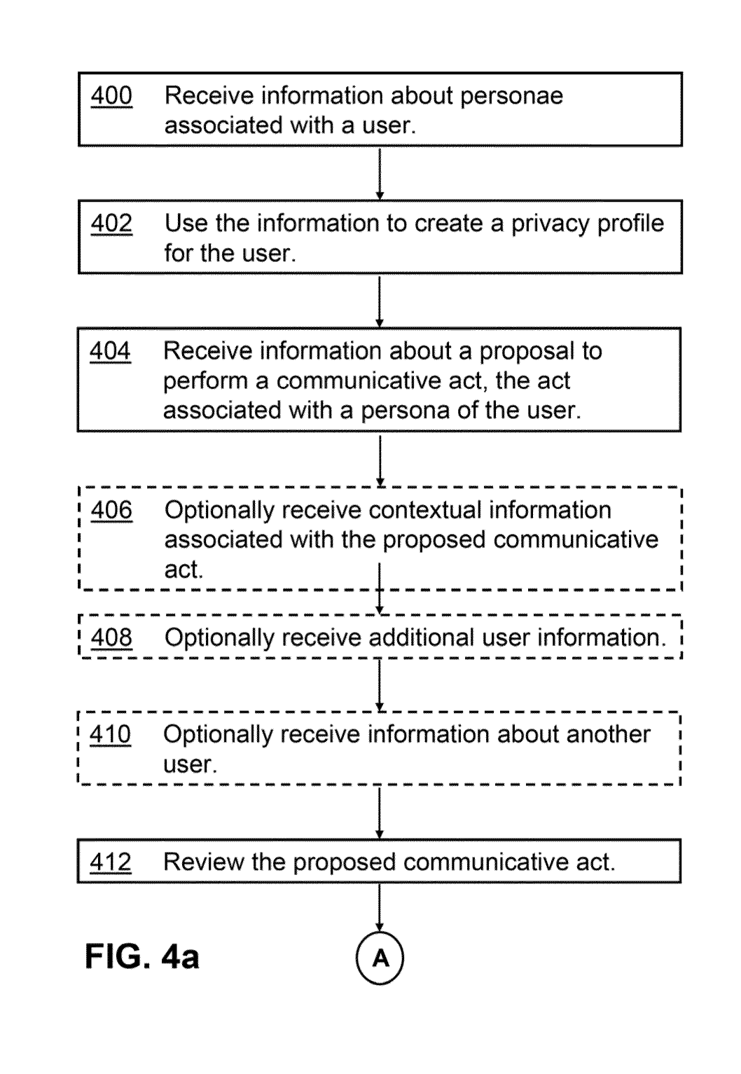

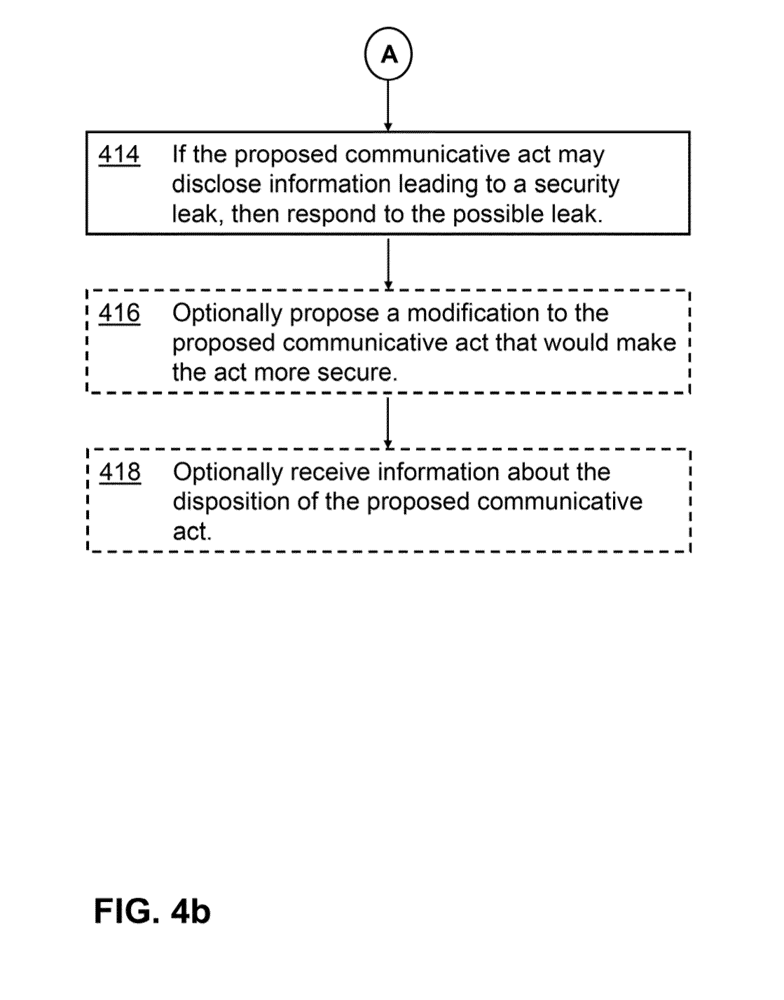

Also shown in FIG. 1 is a privacy server 110, useful in some embodiments of the present disclosure. The particular uses of the privacy server 110 are discussed below in conjunction with FIG. 4.

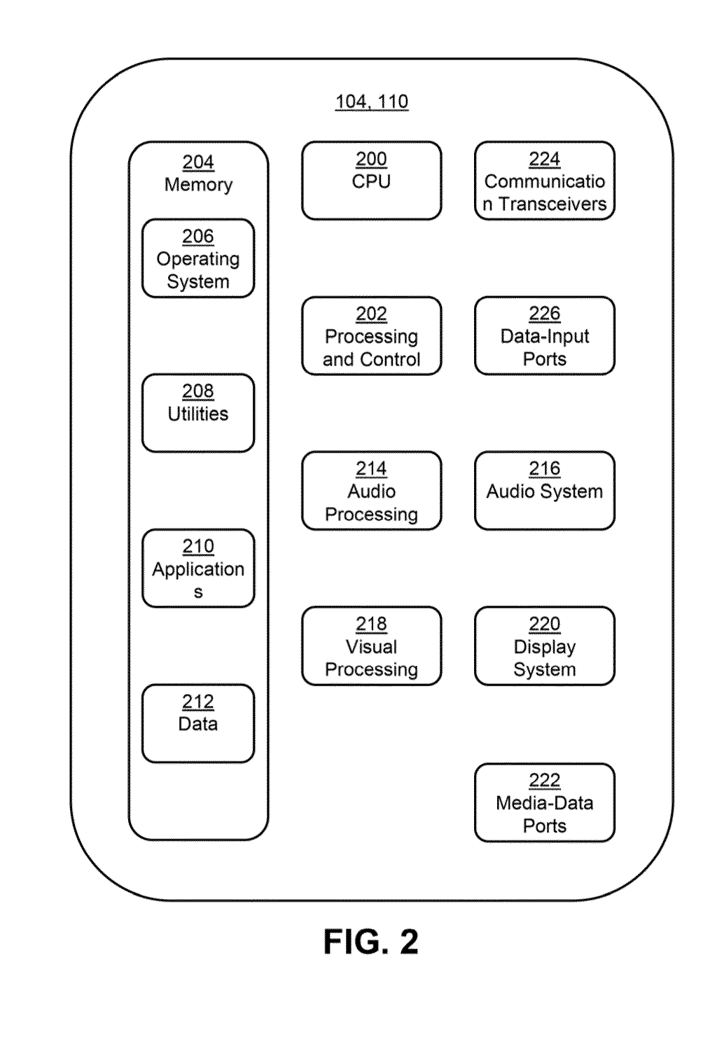

FIG. 2 shows the major components of a representative electronic device 104, 110. The device 104, 110 could be a personal electronics device (such as a smart phone, tablet, personal computer, or gaming console), a set-top box driving a television monitor, or a compute server. It could even be a plurality of servers working together in a coordinated fashion.

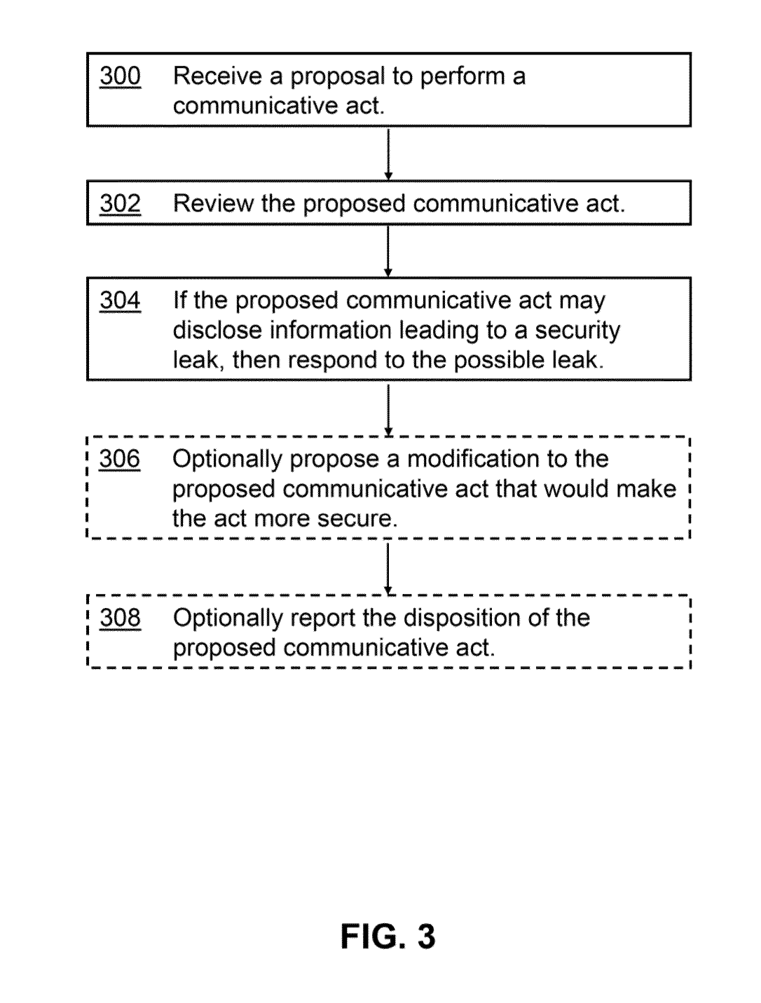

The CPU 200 of the electronic device 104, 110 includes one or more processors (i.e., any of microprocessors, controllers, and the like) or a processor and memory system which processes computer-executable instructions to control the operation of the device 104, 110. In particular, the CPU 200 supports aspects of the present disclosure as illustrated in FIGS. 3 and 4, discussed below. The device 104, 110 can be implemented with a combination of software, hardware, firmware, and fixed-logic circuitry implemented in connection with processing and control circuits, generally identified at 202. Although not shown, the device 104, 110 can include a system bus or data-transfer system that couples the various components within the device 104, 110. A system bus can include any combination of different bus structures, such as a memory bus or memory controller, a peripheral bus, a universal serial bus, and a processor or local bus that utilizes any of a variety of bus architectures.

The electronic device 104, 110 also includes one or more memory devices 204 that enable data storage, examples of which include random-access memory, non-volatile memory (e.g., read-only memory, flash memory, EPROM, and EEPROM), and a disk storage device. A disk storage device may be implemented as any type of magnetic or optical storage device, such as a hard disk drive, a recordable or rewriteable disc, any type of a digital versatile disc, and the like. The device 104, 110 may also include a mass-storage media device.

The memory system 204 provides data-storage mechanisms to store device data 212, other types of information and data, and various device applications 210. An operating system 206 can be maintained as software instructions within the memory 204 and executed by the CPU 200. The device applications 210 may also include a device manager, such as any form of a control application or software application. The utilities 208 may include a signal-processing and control module, code that is native to a particular component of the electronic device 104, 110, a hardware-abstraction layer for a particular component, and so on.

The electronic device 104, 110 can also include an audio-processing system 214 that processes audio data and controls an audio system 216 (which may include, for example, speakers). A visual-processing system 218 processes graphics commands and visual data and controls a display system 220 that can include, for example, a display screen. The audio system 216 and the display system 220 may include any devices that process, display, or otherwise render audio, video, display, or image data. Display data and audio signals can be communicated to an audio component or to a display component via a radio-frequency link, S-video link, High-Definition Multimedia Interface, composite-video link, component-video link, Digital Video Interface, analog audio connection, or other similar communication link, represented by the media-data ports 222. In some implementations, the audio system 216 and the display system 220 are components external to the device 104, 110. Alternatively (e.g., in a cellular telephone), these systems 216, 220 are integrated components of the device 104, 110.

The electronic device 104, 110 can include a communications interface which includes communication transceivers 224 that enable wired or wireless communication. Example transceivers 224 include Wireless Personal Area Network radios compliant with various IEEE 802.15 standards, Wireless Local Area Network radios compliant with any of the various IEEE 802.11 standards, Wireless Wide Area Network cellular radios compliant with 3GPP standards, Wireless Metropolitan Area Network radios compliant with various IEEE 802.16 standards, and wired Local Area Network Ethernet transceivers.

The electronic device 104, 110 may also include one or more data-input ports 226 via which any type of data, media content, or inputs can be received, such as user-selectable inputs (e.g., from a keyboard, from a touch-sensitive input screen, or from another user-input device), messages, music, television content, recorded video content, and any other type of audio, video, or image data received from any content or data source. The data-input ports 226 may include USB ports, coaxial-cable ports, and other serial or parallel connectors (including internal connectors) for flash memory, storage disks, and the like. These data-input ports 226 may be used to couple the device 104, 110 to components, peripherals, or accessories such as microphones and cameras.

FIG. 3 presents a representative method for preventing privacy leaks. In step 300, a “proposal” is made to perform a communicative act.

“Proposal” should be interpreted broadly: In some embodiments, the user 102 is not forced to go through an explicit proposal stage before actually communicating. Instead, he simply orders a communicative act (e.g., he composes an e-mail and then tells his e-mail program to send it). Instead of immediately performing the act, the act is first “intercepted” and reviewed for privacy issues (as discussed in reference to the remaining steps of FIG. 3). In other embodiments, the user 102 may explicitly invoke a review process before performing the act.

Any number of communicative acts are possible besides sending an e-mail such as, for example, uploading a picture with (or without) embedded metadata, posting to a social network, transferring information from the user's computing device 104 to another device, replying to an HTML form, sharing a document, sending an SMS, updating on-line information associated with the user 102, leaving a voicemail, tweeting, and chatting.

Generally speaking, the proposed communicative act is associated with one persona of the user 102. For example, the user 102 has one particular e-mail account that he uses only for communicating with work colleagues 106. Any e-mail sent from that account is associated with the “professional” persona of the user 102.

Before the proposed communicative act is actually performed, it is reviewed in step 302. In some embodiments, the reviewing is performed locally, by the user's personal computing device 104. Alternatively, the act can be reviewed remotely by, for example, a privacy server 110 (discussed in greater detail with reference to FIG. 4).

The reviewing of step 302 looks for possible privacy problems. Well known statistical techniques can be applied here. For example, an analysis of keyword frequencies used by the various personae of the user 102 can show that the text of an e-mail proposed to be sent from the user's professional account may reveal information about that user's social persona. In that case, the proposed e-mail could lead to an inference tying together two of the user's personae, an inference that the user 102 has attempted to avoid by creating the two personae in the first place.

In another example, the proposed communicative act may lead to an unwanted inference about the user 102 himself distinct from any particular persona of the user 102. In one case, multiple pieces of information from multiple communicative acts can be combined to infer something about the user 102 that is not actually stated in any of the communications. For example, communications from the user 102 that include the phrases “I am an engineer” and “I work in Libertyville, Ill.” may be combined to lead to the inference “I work for Motorola” (a large engineering firm located in Libertyville) even though “Motorola” is not mentioned in any of the communications.

The review of step 302 is not limited to these examples but can look for any type of privacy-leaking information that may support any type of possibly unwanted inferences about the user 102 himself or about any of his personae.

Generally speaking, the review of step 302 considers the information in the proposed communication itself. In some embodiments, the user 102 is given an interface with which he states that certain information should be treated with heightened sensitivity. The system itself can decide that some information (e.g., names, personal income) is more sensitive than other information.

In addition to information actually contained within the proposed communication, step 302 preferably uses further information (as available). Often, contextual information associated with the proposed act (e.g., the location of the user 102 when he communicates or social-presence information) may be profitably examined to determine if there is a chance of a privacy leak. Information about the user 102 himself, as distinct from information about the proposed communication, may also be reviewed. This information can include a profile of the user 102, his likes, dislikes, and habits, and other behavioral data.

Many known techniques can be applied in step 302. For example, it is known that, more or less, each individual person tends to use some words and phrases more frequently in his writing than do other individuals. These and other aspects of writing style can often be used to identify an author. Known techniques can be used to extract rare n-grams from the proposed communication. If a statistical distribution of these n-grams closely matches the distribution associated with communications from a second persona of the same user 102, then the inference can be drawn that the persona associated with the proposed communication is related to (or at least, writes like) the second persona and thus that these may be two personae of the same user 102.

In another known technique, the set of per-device instance identifiers in attachments or insertions to the proposed communication (e.g., a camera identifier in the metadata associated with a captured image) can be compared to a set of such identifiers associated with a second persona of the user 102. Again, a close match supports an unwanted inference.

Other known statistical techniques can be applied. In some of these, writings of a large population are analyzed. A “test” document associated with an individual persona is compared, using statistics of term frequency and other writing attributes, to the population at large. Then the proposed communication can be compared against both the population at large and against the test document. If the proposed communication is much closer statistically to the test document than to the population, then the persona associated with the proposed communication may be inferred to be related to the persona associated with the test document.

Generally speaking, all of these statistical techniques provide probabilities rather than certainties. If the probability that the proposed communication supports an unwanted inference is greater than some threshold, then the method of FIG. 3 proceeds.

If the review of step 302 supports the conclusion that the proposed communicative act may lead to a privacy leak, then the system responds in some manner (step 304). A very strict embodiment could simply block the act from being performed and alert the user 102 of that fact. Another embodiment could warn the user 102 and let him decide whether or not he wishes to take the risk. In any case, it could be useful to provide some information to the user 102 such as the unwanted inference potentially supported by the proposed communication, an estimated probability associated with that inference, a confidence rating for the estimated probability, and an indication of what information in the proposed communicative act would possibly support the inference.

Some embodiments could use the information described at the end of the previous paragraph and propose (step 306) a modification to the proposed communication. The modification would lessen the probability of a privacy leak. For example, a dollar amount or a person's name could be noted as potentially sensitive and a more generic alternative (or a deletion of the sensitive word) suggested to the user. In general, the user 102 could then choose to perform either the original or the modified communicative act.

If a privacy server 110 supports this user 102, then, in step 308, the privacy server 110 could be informed of the proposed communicative act, contextual and other information associated with the act and with the user 102 (as described above), and the actual disposition of the act (e.g., performed as proposed, performed as modified, or not performed at all).

The method of FIG. 3 can be performed by the privacy server 110. The privacy server 110 can also perform the somewhat enhanced method of FIGS. 4a and 4b. This method begins, in step 400 of FIG. 4a, when the privacy server 110 receives information about the user 102 himself and about his multiple personae. Any type of information (e.g., age, income, gender, preferences, scholastic history, and like) may be entered or gathered here. It is contemplated that, in some situations at least, the user 102 will directly provide sensitive personal information (via, for example, a secure data-entry interface hosted by the privacy server 110). The user 102 can also allow the privacy server 110 to access and review some or all of his past and future communications.

The privacy server 110 uses the information about the user 102 to create a privacy profile in step 402. Known techniques can be applied here. Keywords and themes can be extracted from the user's communications to determine his writing style (as discussed above in reference to step 302 of FIG. 3). The personal information entered by the user 102 can be combined with publicly available information and with relevant demographics.

Here, the privacy server 110 has a number of advantages over performing the method on the user's personal computing device 104. First, the user 102 may not wish to store information about all of his personae on his device 104, for fear of cross-persona privacy leaks and for fear that the device 104 would be lost or stolen. By having access to all of the user's personae, the privacy server 110 is in a better position to detect possible threats across all of the personae. Similarly, the privacy server 110 will, in some situations, have access to more communications streams of the user 102 (that is, beyond the communications implemented by the device 104) and can thus craft a more detailed profile. Finally, the privacy server 110 can implement stronger safety measures and, with access to greater computing power, more in-depth analysis.

Having created the privacy profile, the profile is used in the remainder of the method of FIGS. 4a and 4b in a manner similar to the method of FIG. 3. The proposal to perform a communicative act is received in step 404 (parallel to step 300 of FIG. 3), the proposal is reviewed in step 412 (parallel to step 302), a warning is issued, if appropriate, in step 414 of FIG. 4b (parallel to step 304), and, optionally, a modification to the proposal is presented that could be more secure (step 416, parallel to step 306).

Some differences between the methods of FIGS. 3 and 4 are worthy of note. Because the privacy server 110 is, generally speaking, remote from the user 102, it operates on information that it receives from the user's personal computing device 104 (in addition to the privacy profile, of course). Thus, the privacy server 110 optionally receives information about the context of the proposed communication and about the user 102 himself in steps 406 and 408.

In step 410, the privacy server 110 optionally receives information about a user other than the user 102 who proposes the communicative act under review. This step is shorthand for another application of steps 400 and 402 to create a privacy profile for this second user. This is another example of why a method running on the privacy server 110 can be more powerful than a method running on the user's personal computing device 104. The privacy server 110 can have profiles of numerous people. It can use the information from multiple people to create associative models and then use those models when reviewing the proposed communicative act (in step 412). While the privacy server 110 is careful to avoid leaking information among the users that it profiles, the added information provided by the associative models can lead to a more insightful review of potential privacy leaks.

In step 418, the privacy server 110 optionally receives information about what the user 102 actually did with the proposed communicative act (see also step 308 of FIG. 3). This information can be used to update the user's privacy profile.

In view of the many possible embodiments to which the principles of the present discussion may be applied, it should be recognized that the embodiments described herein with respect to the drawing figures are meant to be illustrative only and should not be taken as limiting the scope of the claims. Therefore, the techniques as described herein contemplate all such embodiments as may come within the scope of the following claims and equivalents thereof.

We claim:

1. On a computing device, a method for responding to a possible privacy leak, the method comprising:
receiving, by the computing device, a proposal to perform a communicative act, the proposed communicative act associated with a persona of a first user, the first user having a plurality of personae;
reviewing the proposed communicative act;
based, at least in part, on the reviewing, determining that the proposed communicative act may disclose information supporting an inference selected from the group consisting of: an inference linking two of the first user's personae, an inference about a persona of the first user distinct from the persona associated with the proposed communicative act, and an inference about the first user based, at least in part, on information from a plurality of the first user's personae; and
based, at least in part, on the determining, responding, by the computing device, to the proposed communicative act.

2. The method of claim 1 wherein the proposed communicative act is selected from the group consisting of: sending an e-mail, uploading a picture with embedded metadata, posting to a social network, transferring information from the computing device to another device, replying to an HTML form, sharing a document, sending an SMS, updating on-line information associated with the first user, leaving a voicemail, tweeting, and chatting.

3. The method of claim 1 wherein reviewing further comprises reviewing contextual information associated with the proposed communicative act.

4. The method of claim 1 wherein reviewing further comprises reviewing user information selected from the group consisting of: a profile of the first user, a preference explicitly stated by the first user, usage data, contextual data, and behavioral data.

5. The method of claim 1 wherein the inference is associated with an element selected from the group consisting of: a user-supplied sensitivity rating and a system-estimated sensitivity rating.

6. The method of claim 1 wherein reviewing further comprises:
sending, to a privacy server, information about the proposed communicative act;
wherein reviewing is performed, at least in part, by the privacy server.

7. The method of claim 1 wherein responding comprises alerting the first user that the proposed communicative act may disclose information supporting the inference.

8. The method of claim 7 wherein alerting comprises presenting to the first user an element selected from the group consisting of: the possibly supported inference, an estimated probability associated with the possibly supported inference, a confidence rating for the estimated probability, and an indication of what information in the proposed communicative act would possibly support the inference.

9. The method of claim 7 further comprising:
receiving an indication to perform the proposed communicative act;
performing the proposed communicative act; and
sending, to a privacy server, information that the proposed communicative act was performed.

10. The method of claim 1 wherein responding comprises blocking the proposed communicative act.

11. The method of claim 1 wherein responding comprises:
modifying the proposed communicative act, the modifying based, at least in part, on the reviewing;
performing the modified proposed communicative act; and
sending, to a privacy server, information that the modified proposed communicative act was performed.

12. The method of claim 1 further comprising:
sending, to a privacy server, information associated with one of the first user's personae.

13. A computing device configured for responding to a possible privacy leak, the computing device comprising:
a communications interface; and
a processor operatively connected to the communications interface and configured for:
receiving a proposal to perform a communicative act, the proposed communicative act associated with a persona of a first user, the first user having a plurality of personae;
reviewing the proposed communicative act; and
based, at least in part, on the reviewing, determining that the proposed communicative act may disclose information supporting an inference selected from the group consisting of: an inference linking two of the first user's personae, an inference about a persona of the first user distinct from the persona associated with the proposed communicative act, and an inference about the first user based, at least in part, on information from a plurality of the first user's personae; and
based, at least in part, on the determining, responding to the proposed communicative act.

14. The computing device of claim 13 wherein the computing device is selected from the group consisting of: a personal electronics device, a mobile telephone, a personal digital assistant, a computer, a tablet computer, a set-top box, a gaming console, a compute server, and a coordinated group of compute servers.

15. On a privacy server, a method for responding to a possible privacy leak, the method comprising:
receiving, by the privacy server from a first user having a plurality of personae, first information about a first persona of the first user;
receiving, by the privacy server from the first user, second information about a second persona of the first user, the first and second personae of the first user distinct;
based, at least in part, on the received first and second information, creating, by the privacy server, a privacy profile for the first user;
receiving, by the privacy server, information about a proposed communicative act, the proposed communicative act associated with a persona of the first user;
reviewing, by the privacy server, the proposed communicative act; and
based, at least in part, on the reviewing and on the first user's privacy profile, determining, by the privacy server, that the proposed communicative act may disclose information supporting an inference selected from the group consisting of: an inference linking two of the first user's personae, an inference about a persona of the first user distinct from the persona associated with the proposed communicative act, and an inference about the first user based, at least in part, on information from a plurality of the first user's personae; and
based, at least in part, on the determining, responding, by the privacy server, to the proposed communicative act.

16. The method of claim 15 wherein the proposed communicative act is selected from the group consisting of: sending an e-mail, uploading a picture with embedded metadata, posting to a social network, transferring information from the computing device to another device, replying to an HTML form, sharing a document, sending an SMS, updating on-line information associated with the first user, leaving a voicemail, tweeting, and chatting.

17. The method of claim 15 further comprising:
receiving contextual information associated with the proposed communicative act;
wherein reviewing further comprises reviewing the contextual information.

18. The method of claim 15 further comprising:
receiving user information selected from the group consisting of: a profile of the first user, a preference explicitly stated by the first user, usage data, contextual data, and behavioral data;
wherein reviewing further comprises reviewing the user information.

19. The method of claim 15 wherein the inference is associated with an element selected from the group consisting of: a user-supplied sensitivity rating and a system-estimated sensitivity rating.

20. The method of claim 15 wherein responding comprises sending an alert that the proposed communicative act may disclose information supporting the inference.

21. The method of claim 20 wherein the alert comprises an element selected from the group consisting of: the possibly supported inference, an estimated probability associated with the possibly supported inference, a confidence rating for the estimated probability, and an indication of what information in the proposed communicative act would possibly support the inference.

22. The method of claim 15 wherein responding comprises sending a suggestion that the proposed communicative act be blocked.

23. The method of claim 15 further comprising:
receiving third information that the proposed communicative act was performed; and
based, at least in part, on the received third information, updating the first user's privacy profile.

24. The method of claim 15 further comprising:
receiving third information that a modification of the proposed communicative act was performed; and
based, at least in part, on the received third information, updating the first user's privacy profile.

25. The method of claim 15 further comprising:
receiving, by the privacy server from a second user having a plurality of personae, third information about a first persona of the second user, the second user distinct from the first user;
receiving, by the privacy server from the second user, fourth information about a second persona of the second user, the first and second personae of the second user distinct;
based, at least in part, on the received third and fourth information, creating, by the privacy server, a privacy profile for the second user; and
based, at least in part, on the privacy profiles for the first and second users, creating an associative model;
wherein determining is further based on the associative model.

26. A privacy server configured for responding to a possible privacy leak, the privacy server comprising:
a communications interface configured for receiving, from a first user having a plurality of personae, first information about a first persona of the first user and second information about a second persona of the first user, the first and second personae of the first user distinct; and
a processor operatively connected to the communications interface and configured for:
based, at least in part, on the received first and second information, creating a privacy profile for the first user;
receiving, via the communications interface, information about a proposed communicative act, the proposed communicative act associated with a persona of the first user;
reviewing the proposed communicative act;
based, at least in part, on the reviewing and on the first user's privacy profile, determining, by the privacy server, that the proposed communicative act may disclose information supporting an inference selected from the group consisting of: an inference linking two of the first user's personae, an inference about a persona of the first user distinct from the persona associated with the proposed communicative act, and an inference about the first user based, at least in part, on information from a plurality of the first user's personae; and
based, at least in part, on the determining, responding, via the communications interface, to the proposed communicative act.

27. The privacy server of claim 26 wherein the privacy server is selected from the group consisting of: a compute server and a coordinated group of compute servers.
